(19) United States
(12) Patent Application Publication
(10) Pub. No.: US 2002/0010769 A1
(43) Pub. Date: Jan. 24, 2002

(54) Autonomous browsing agent

(76) Inventors: Roland Calvin Kippenhan III, Redwood City, CA (US); Theodore Charles Goldstein, Palo Alto, CA (US); Matthew Finbarr Cassidy, San Francisco, CA (US); Andrew Jay Sells, Burlingame, CA (US); William Bradford Chase, San Francisco, CA (US); Joseph Pearce, San Francisco, CA (US)

Correspondence Address: Virginia H. Meyer, Esq., 475 Gate Five Road, Suite 275, Sausalito, CA, 94965, US

(21) Appl. No.: 09/769,002

(22) Filed: Jan. 23, 2001

Related U.S. Application Data
(63) Continuation-in-part of application No. 09/338,912, filed on Jun. 23, 1999.
(60) Provisional application No. 60/216,472, filed on Jul. 6, 2000.

(51) Int. Cl. G06F 15/173; G06F 15/16; G06F 17/60

(52) U.S. Cl. 709/223; 709/218; 705/28

(57) ABSTRACT

Methods and systems for implementing and supporting an autonomous software agent that assists the user during a web browsing or navigation session on a computer network are disclosed. According to one embodiment, the agent operates in a limited, unobtrusive mode wherein the agent notifies the user that a command option may exist and allows the user the option to launch the full functionality of the browsing agent.

### RELATED APPLICATIONS

The present application is a continuation-in-part of U.S. application Ser. No. 09/338,912, filed Jun. 23, 1999 and further claims priority from U.S. Provisional Application No. 60/216,472, filed Jul. 6, 2000.

### FIELD OF THE INVENTION

The present invention relates to computer networks. More specifically, the present invention provides methods and systems for providing an autonomous software agent that assists a user during browsing sessions on a computer network.

### BACKGROUND OF THE INVENTION

The Internet is a global network of millions of computers belonging to various commercial and non-profit entities such as corporations, universities, and research organizations. The computer networks of the Internet are connected by gateways that handle data transfer and conversion of messages from a sending network to the protocols used by a receiving network. The Internet's collection of networks and gateways use the TCP/IP protocol. TCP/IP is an acronym for Transport Control Protocol/Internet Protocol, a software protocol developed by the Department of Defense.

The increasing use of wide area networks such as the Internet has resulted in an explosion in the provision of on-line services. Computer users can access a vast wealth of information and services by utilizing a wide area network to establish a connection with other computers connected to the network.

Typically, the computers connected to a wide area network such as the Internet are identified as either servers or clients. A server is a computer that stores files that are available to other computers connected to the network. A client is a computer connected to the network that accesses the files and other resources provided by a server. To obtain information from a server, a client computer makes a request for a file or information located on the server using a specified protocol. Upon receipt of a properly formatted request, the server downloads the file to the client computer.

The World Wide Web is a system of Internet servers using specified Internet protocols and supporting specially formatted documents. The HyperText Transfer Protocol (“HTTP”) is the underlying protocol used by the World Wide Web. HTTP defines how messages are formatted and transmitted, and what actions Web servers and browsers should take in response to various commands. The other main standard of the World Wide Web is Hyper-Text Markup Language (“HTML”), which covers how documents and files are formatted and displayed. HTML supports links to other documents, as well as graphics, audio, and video files.

Users access the content contained on the Internet and the World Wide Web with an Internet Browser, which is a software application used to locate and display web pages. A Web page is a document on the World Wide Web. Every Web page or file on a web server is identified by a unique Uniform Resource Locator. A Uniform Resource Locator (“URL”) is the global address of files and other resources on the Internet. The address indicates the protocol being used and specifies the IP address or the domain name where the file or resource is located. Typically, a URL identifies the name of the server and the path to a desired file on the server. For example, a URL for a particular file on a web server may be constructed as follows: “http://<server>/<filepath>”, where <server> identifies the server on which the file is located and <filepath> identifies the path to the file on the server. Thus, with the name of the server and the correct path to a file, a properly formatted URL accesses a desired file on a server connected to the World Wide Web.

The Internet has quickly become a means for not only obtaining information, but for conducting commercial transactions. As one can imagine, there are myriad documents and files corresponding to a vast array of information and services accessible on the Internet. Indeed, it is impossible for users to exhaust all the resources available on the Internet. Accordingly, as users of the Internet's World Wide Web encounter increasing amounts of Web-delivered information and services, they need a method and system that monitors the actions of the user while he or she is browsing a web site and offers the user assistance and/or more information relating to the currently viewed page. For example, every transaction conducted over the Internet requires the consumer to provide information necessary to complete the transaction. A typical web page presents an interface that the consumer fills out to access more information, for example, or order a product. For instance, a customer may access a particular merchant web site and order a product advertised on that web site. To complete the transaction, the merchant web server presents a web page with an interface requiring certain information from the user, such as name, delivery address, and payment information. Anyone who has encountered such interfaces recognizes that providing the required information is often a tedious process.

Accordingly, a need exists for a method and system that automates the operation of Web page-based interfaces, including, for example, input field data entry and page-based information gathering. Furthermore, since each Web page may include a different interface or otherwise be interacted with in a unique manner, such a method or system must be able to identify the web page to which the user is navigating with his or her browser, and be “aware” of what may be done there and how to accomplish it.

As discussed above, there are numerous resources accessible over the Internet. However, retrieving desired information on the Internet requires knowledge of an associated URL. Accordingly, if, for example, a consumer wishes to obtain information about or order a particular company's product on the World Wide Web, she must know the URL (data location) corresponding to that company's web site. As a user navigates through a particular web site, however, she may wish to receive more information about a particular subject. For example, a consumer may wish to find out the price at which other merchants are offering a particular book. In this instance, the user must manually browse other merchant sites. When a specific URL or data location is not known, search engines are a way of locating desired URLs pointing to desired information. Typically, a user enters key words or search terms into a search engine, which returns a list of URLs corresponding to web sites or USENET groups where the key words or search terms were found. The use of search engines, however, can be a time-consuming process. Often, a user would like assistance with either complex or routine tasks, such as coping with an overabundance of search results, finding specific goods or information, filtering information, filling in web forms, and navigating complex web sites. In general, a user would often like an intelligent agent that can assist the browser operator (user). In light of the above, a need exists for a method and system that monitors the user's actions while browsing and offers assistance and/or more information relating to the actions the user performs on a web site. The present invention substantially fulfills the above-identified needs.

### SUMMARY OF THE INVENTION

The present invention provides methods and systems for implementing and supporting an autonomous software agent that assists the user during a web browsing or navigation session on a computer network. In one embodiment, the present invention contemplates that the computer network includes at least one client computer associated with one or more users, at least one server associated with a provider of goods, services and/or information, and at least one browsing agent server associated with an autonomous browsing agent. The method according to one embodiment of the present invention comprises (a) monitoring, at the client computer, a click stream; (b) transmitting click stream data to the browsing agent server, the click stream data being derived from the click stream; (c) receiving control data corresponding to the click stream data; (d) offering a command option to the user, the command option based on the control data; and (e) performing the command option, if the user selects it. Certain embodiments of the present invention are directed towards minimizing the obtrusiveness of the display and/or operation of the browsing agent. To reduce the processing and time demands associated with transmitting clickstream data to a remote server and receiving control data in return, the browsing agent, in one embodiment, is configured to scan pages or forms for elements characteristic of pages or forms upon which the browsing agent can operate. If the page or form includes such characteristics, the browsing agent displays a browsing agent launch window that, in one embodiment, allows the user to launch the full functionality of the browsing agent to transmit click stream data and receive control data in return.

In one embodiment, control data is data or information transmitted by the browsing agent server to the autonomous browsing agent. As discussed more fully below, control data may include programming instructions, which the browsing agent uses to operate on a page-based interface. In another embodiment, control data also refers to the results of an Internet search transmitted to browsing agent. In one embodiment, a click stream is the sequence of events the user encounters and the actions the user takes when browsing a computer network. A click stream, in one embodiment, may comprise a series of web pages, network addresses, any data the user inputs into a form and/or any thing the user clicks on.

### BRIEF DESCRIPTION OF THE DRAWINGS

FIG. 1A is a schematic block diagram illustrating the operation of one preferred embodiment of the method and system of the present invention.

FIG. 1B is a schematic block diagram illustrating an alternative embodiment of the present invention.

FIG. 2 is a flow chart diagram illustrating a method according to an embodiment of the present invention.

FIG. 3 is a flow chart diagram illustrating a second method according to an embodiment of the present invention.

FIG. 4 is a flow chart diagram illustrating a third method pursuant to another embodiment of the present invention.

FIG. 5 is a flow chart diagram setting forth a method according to another embodiment of the present invention.

FIG. 6 illustrates a browser application window and the browsing agent launch window according to one embodiment of the present invention.

FIG. 7A illustrates an embodiment of an interface for logging into browsing agent site 40.

FIG. 7B illustrates an embodiment of an interface presented by the browsing agent of the present invention allowing the user the option to automatically complete a “log-in” form.

### DETAILED DESCRIPTION OF PREFERRED EMBODIMENTS

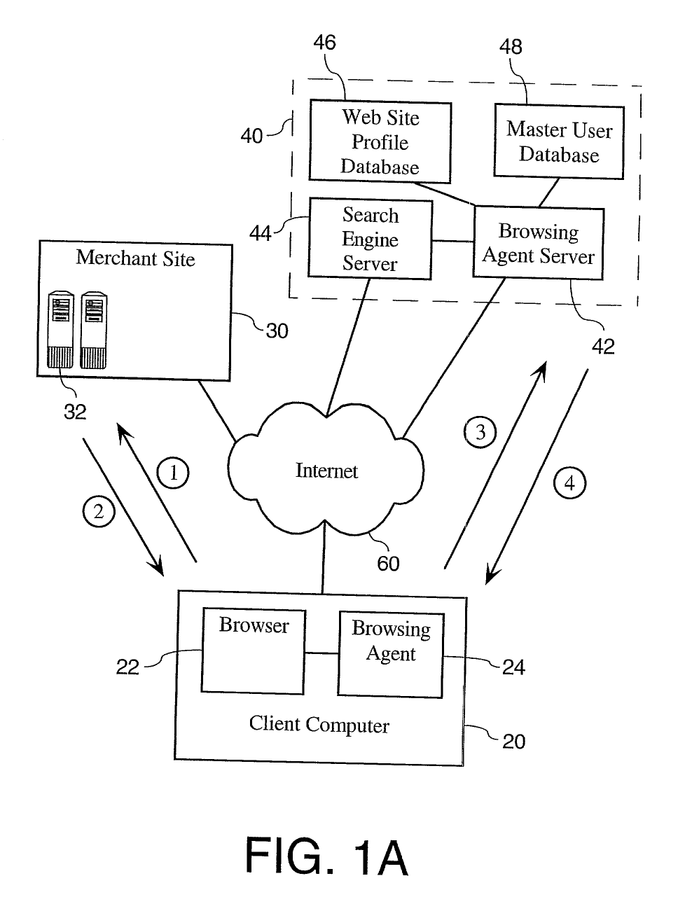

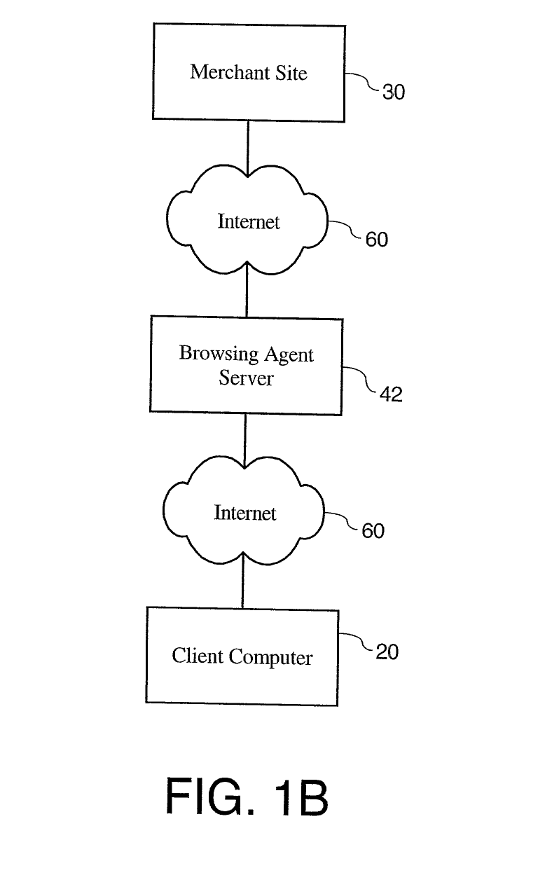

FIG. 1A illustrates one preferred embodiment of the present invention. In one embodiment, the present invention generally involves at least one client computer 20, at least one merchant or web site 30, and browsing agent site 40, all of which are connected to the Internet 60. Of course, one skilled in the art will recognize that the present invention can be applied to any wide area and, in some embodiments, local area computer network. Moreover, suitable computer networks include an electronic computer network, an optical computer network, a wireless computer network, and/or any combination of the foregoing. In addition, FIG. 1B illustrates a variation of the information flow depicted in FIG 1A. The system illustrated in FIG. 1B shows the communication paths going through browsing agent server as a proxy server. Those skilled in the art will know that either of the implementations illustrated in FIGS. 1A and 1B is possible and that the architectures represented therein offer different engineering trade-offs.

As is conventional, merchant or web site 30 is supported by web or Internet servers 32, which receive requests submitted by users and transmit files and other documents in return. As FIG. 1A shows, in one embodiment, servers 32 are connected to the Internet 60.

Users access information and services on computer network 60 with a network access device, which receives, displays and transmits data over a computer network. In one embodiment, a network access device is a browser 22 executed on a personal computer (such as user computer 20), a browser executed on a network computer, or a browser on a cell phone or personal digital assistant. However, any suitable device and/or application for accessing files over a computer network can be used.

As FIG. 1A shows, one embodiment of the present invention works in conjunction with a conventional computer having an Internet browser 22 and a connection to the Internet 60. The user's computer 20 can be any conventional personal computer known in the art. In preferred form, user computer 20 includes at least one processor, a data storage system (including volatile and non-volatile media), a keyboard, a display device (such as a CRT, LCD, or LED display), at least one input device and at least one output device. In one preferred embodiment, the user's computer is connected to the Internet via a modem dial-up connection or through a network line. Such communication could also be wireless.

According to one embodiment of the invention, client computer 20 also includes browsing agent client 24. Browsing agent client 24 may be implemented in hardware, software or a combination of both. In preferred form, browsing agent client 24 is a software application executed on client computer 20 in a conventional manner. As is more fully described below, browsing agent client 24 works in connection with browser 22. More specifically, browsing agent client 24, in one embodiment, monitors the user's activity on browser 22 and sends data relating to such activity (click stream data) to browsing agent site 40. As discussed below, in another embodiment, browsing agent client 24 (operating in a limited mode) scans or monitors the currently-viewed page or form for characteristics indicative of a page or form upon which the browsing agent can operate without transmitting click stream data to a remote server. In one embodiment, if the page or form includes such characteristics, browsing agent client 24 allows the user to elect to launch the full functionality of browsing agent client 24 to transmit click stream data and receive control data in return.

Similar to web site 30, browsing agent site 40, in one embodiment, is supported by servers 42 connected to the Internet 60. Browsing agent servers 42 receive click stream data from browsing agent client 24 and transmit control data in response. In one embodiment, browsing agent site 40 includes search engine server 44, web site profile database 46, and master user database 48. Web site profile database 46 and master user database 48 can be any database known in the art. In one embodiment, each database is implemented in hardware including a collection of computer programs enabling the storage, modification, and extraction of information on the database. Database hardware may range from personal computers (for small systems) to mainframes (for large systems). In addition, browsing agent servers 42 may be implemented in hardware or software, or preferably a combination of both. In preferred form, the server is implemented in computer programs executing on programmable computers each comprising at least one processor, a data storage system (including volatile and non-volatile media), at least one input device, and at least one output device. As is more fully described below, browsing agent servers 42, in one embodiment, receive data from browsing agent client 24, perform certain pre-defined actions based on the transmitted data, and transmit responses back to browsing agent client 24. As one skilled in the art will recognize, however, the databases described above may reside on browsing agent server 42 or may be physically separate, but operably connected thereto.

### Operation

In operation, the user launches Internet browser 22 on client computer 20 to begin a session. According to one embodiment of the invention, browsing agent client 24 is also launched and operates within a separate, smaller Web page window maintained by Internet browser 22. In preferred form, the smaller window remains in the background, obscured by the window containing the page currently viewed in the main display of Internet browser 22.

In one preferred embodiment, the user's session begins by logging into an account with browsing agent site 40. In this embodiment, browsing agent client 24 appears in the foreground during login. More specifically, a user using client computer 20 accesses an account stored on master user database 48 operably connected to servers 42 of browsing agent site 40. According to one embodiment, the user's account includes a user name, and a password or an encrypted representation thereof.

Servers 42 authenticate users in a conventional manner. In one embodiment, server 42 prompts the user for a user name and a password to authenticate the user. Numerous authentication protocols are known in the art. The actual authentication protocol used is not critical to the invention. In one preferred embodiment, the records corresponding to each account contain the user name and a salted one-way hash of the user's password. Therefore, each user is authenticated by hashing the inputted password with the “salt” and comparing the result to the hash value stored in the user's record. If there is a match, the user is deemed to be authentic.

According to one embodiment of the present invention, the user has provided browsing agent site 40 with certain standard information normally required for completing transactions and/or other forms. Such user information may include, but is not limited to, name, address, account identifiers, passwords, delivery address, and payment information, such as credit card, type, number and expiration date. As discussed more fully below, this information can be stored locally by browsing agent client 24 or remotely in an account on browsing agent server 42 or master user database 48. Furthermore, other user information may be stored. For example, such information can include personal preferences, medical history, financial information, demographic information, transaction history, scholastic information, business information, as well as any other information that the present invention could use to assist the user in interacting with the Internet or other computer network.

Upon proper authentication of the user, browsing agent client 24, in one embodiment, drops into the background, allowing the main browser window to be displayed. The user then accesses web site 30 and requests a page or document, as is conventional. (See FIG. 1A, Ref. #1.) In response, web site 30 transmits the requested page. (See FIG. 1A, Ref. #2.) According to one embodiment, browsing agent client 24, operating in the background, monitors the user's activity on browser 22 and transmits click stream data relating to such activity to browsing agent server 42. (See FIG. 1A, Ref. #3.)

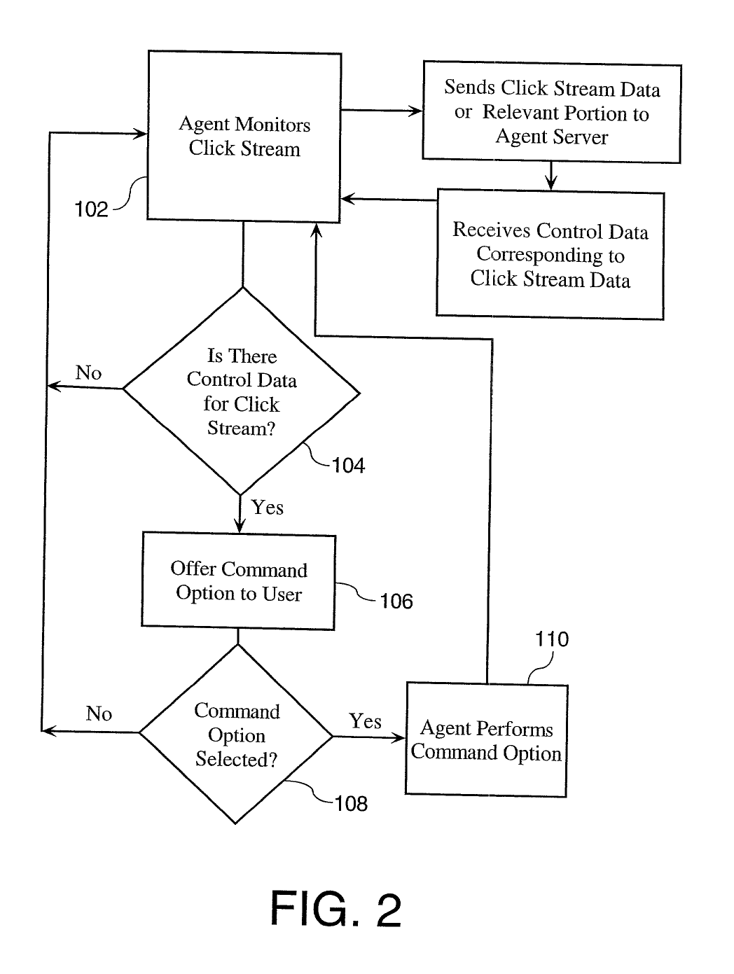

In one embodiment, browsing agent client 24 obtains the address of the Web page currently viewed in Internet browser 22 and stores this address in a variable memory location within browsing agent client 24. (See FIG. 1A, Ref. #3 and FIG. 2, step 102.) Browsing agent client 24 transmits the address of the currently viewed Web page to browsing agent server 42, which compares it to the addresses or sub-strings of addresses stored in web site profile database 46. If the address of the currently viewed Web page matches an address or sub-string stored in profile database 46, programming instructions or control data associated with the matching address are obtained from profile database 46 and delivered via the Internet 60 to browsing agent client 24. (See FIG. 2, steps 102 and 104.) In another embodiment, the browsing agent has inserted monitoring hooks into browser 22 using a variety of techniques exposed by the browser's application programming interfaces (APIs). The specific mechanisms used are not critical to the invention.

In one form, browsing agent client 24, in a cycle repeated many times per second, obtains the address of the currently viewed Web page from Internet browser 22 by comparing it each time to the address it has stored in its variable memory location. In this way, browsing agent client 24 determines when the user has navigated to a new Web page destination. As is conventional in the art, the user navigates to a Web page other than that currently viewed in Internet browser 22 by manually entering it into the appropriate field or by clicking on links contained in the currently viewed page. Browser 22 connects to web server 32 and requests a file corresponding to the address or URL specified by the user.

According to one embodiment of the invention, when the user specifies a new page address, browsing agent client 24 obtains the address of the new page and compares this address to that stored in its variable memory location and determines that it is different. Browsing agent client 24 stores the address of the newly specified page in its variable memory location, and sends it to browsing agent server 42, which compares it to addresses stored in profile database 46. As discussed above, if browsing agent server 42 determines that the address of the new page matches an address stored in profile database 46, control data associated with the address of the page are obtained from profile database 46 and delivered via the Internet 60 to browsing agent client 24. If no matching address is found, browsing agent client 24 merely continues its repeating cycle until the user specifies a new page. (See FIG. 2, step 104.)

In one embodiment, the control data associated with the Destination Web Page provide browsing agent client 24 with the data to be inserted into the data fields contained within an interface of the currently viewed page. Browsing agent client 24, now equipped with programming instructions relevant to the currently viewed page, comes into the foreground on the user's video display. (See FIG. 2, step 106.) Interface controls relevant to the programming instructions are made visible to the user by browsing agent client 24. Using the interface controls, the user may command browsing agent client 24 to insert the data into the data fields appearing in the interface of the currently viewed page. (See FIG. 2, steps 108 and 110.) Once the command option is performed, browsing agent client 24 then transfers to the background and resumes its monitoring of the click stream on browser 22.

For example, and in one embodiment, the present invention has application to a web site corresponding to an on-line music store. As is conventional, the user navigates through the on-line music store and selects various compact discs and audio tapes he wishes to purchase. As discussed above, as the user navigates among the various web pages provided by the on-line music store web server, browsing agent client 24 transmits corresponding addresses or other click stream data to browsing agent server 42, which looks for matches in profile database 46. When the user indicates that he is ready to purchase his selections, the on-line music store presents a web page having an interface including certain data fields. These data fields may include the user's name, address, telephone number, credit card number and expiration date. According to one embodiment, the address corresponding to this web page is communicated to browsing agent server 42 which finds a corresponding entry in profile database 46. Browsing agent server 42 then accesses master user database 48 and formats the data corresponding to the user's account according to the web page profile stored in profile database 46. Browsing agent server 42 then transmits to browsing agent client 24 the user's data formatted according to the programming instructions or interface profile associated with that particular web page. Browsing agent client 24 appears in the foreground and provides an interface control presenting a command option which the user may select to direct browsing agent client 24 to insert the data into the data fields of the interface as appropriate. (See FIG. 2, steps 108 and 110.) Thus, rather than having to manually enter the information into the data fields, the user simply clicks on a button in the interface control provided by browsing agent client 24 to enter the information necessary to complete the transaction.

In one form, browsing agent client 24 carries out the command and returns to the background on the user's video display. Browsing agent client 24 then resumes its cycle of repeatedly obtaining the address of the currently viewed page from browser 22, comparing it each time to the address it has stored in its variable memory, to determine when the user has navigated to a new page.

In other preferred embodiments, browsing agent client 24 itself stores the data particular to a user. In a preferred form, such data is stored in encrypted form. In one embodiment, when the user logs in to his account and is properly authenticated, browsing agent site 40 transmits a cryptographic key to browsing agent client 24 to decrypt the user's data as necessary. In one embodiment, communication of the cryptographic key and control data, occurs using a secure communications protocol, such as SSL. In this preferred embodiment, the interface profile associated with the currently viewed page provides browsing agent client 24 with programming instructions as to the order and format of the data fields in that page. According to this embodiment, browsing agent client 24 receives control data and inserts the locally stored user data into the data fields according to the interface profile or programming instructions provided by browsing agent server 42 from profile database 46.

In one embodiment, an aspect of the present invention involves creating rules for modeling the user's intentions and generating profiles that model web sites. A web-site of a particular on-line store, for example, often includes more than one interface or form. Accordingly, one embodiment of the present invention groups the interface profiles according to the domain name of the particular web site. For example, a group of interface profiles corresponding to an on-line store web site having four interfaces may be named on-linestore.com.profile1, on-linestore.com.profile2, etc. These interface profiles are stored in web site profile database 46 in association with the corresponding computer network address or URL. In preferred embodiments, the interface profiles are associated with a particular sub-string of the computer network address or URL that contains the particular interface, since often times the current URL or address includes session-specific information.

As discussed above, in one preferred embodiment of the present invention, the databases used in the present invention are arranged into a series of records. The records store information of two kinds: merchant or web site records including the interface profiles corresponding to the merchant or web site and user records. The merchant or web site records model the merchant's web site. The purpose of the merchant model is to map the data from the user's data from standard canonical form (schema) into the specific form required by the merchant. Those skilled in the art know that the precise form of the merchant model can take a variety of forms. In one embodiment, the merchant model is constructed as a stored program written in a scripting language such as JavaScript. But it can take also the form of a simple table of name-value mappings. Those skilled in the art will recognize the performance advantages of representing the mapping process directly as a program.

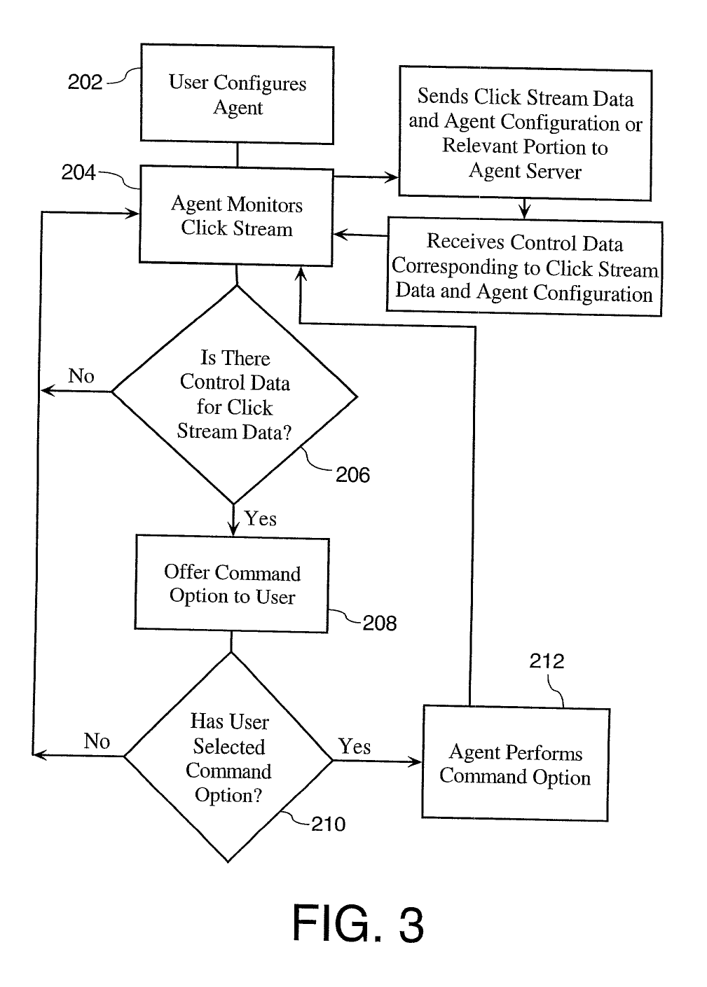

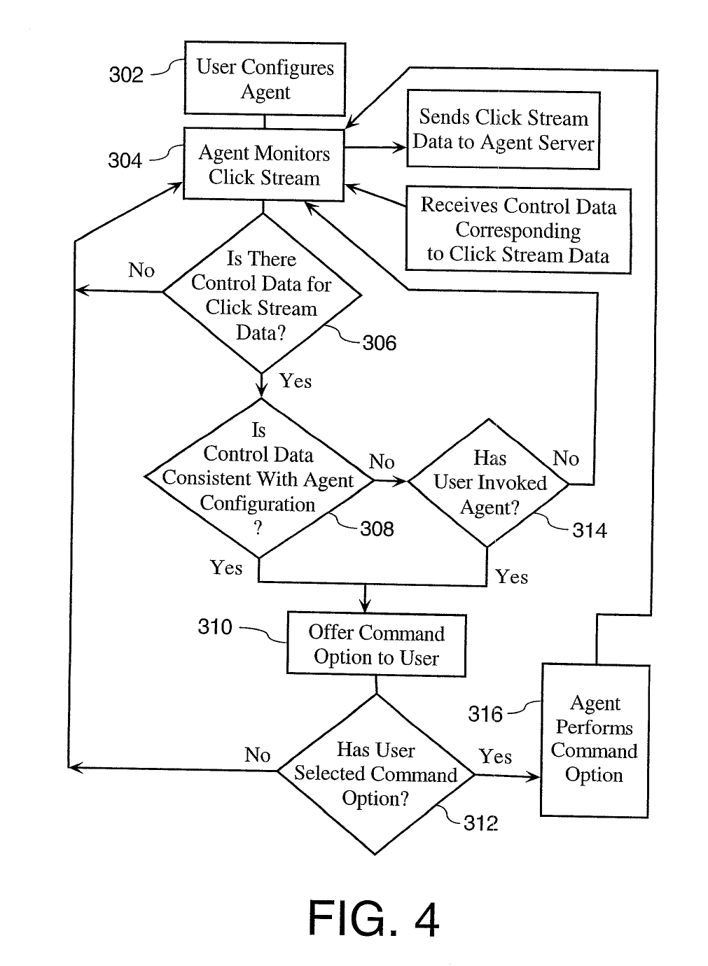

Other preferred embodiments of the present invention are illustrated in FIGS. 3 and 4. As FIG. 3 illustrates, a second preferred embodiment allows the user to configure browsing agent client 24 before a session begins. (See FIG. 3, step 202.) The second preferred embodiment also features the ability to perform searches in the background for information related to the currently viewed page, concurrently with the user's browsing session.

As with the first preferred embodiment, a user using client computer 20 launches browser 22 and browsing agent client 24. In one form, the user logs in to an account as described above. As discussed above, the second preferred embodiment allows the user to configure the agent such that it operates or appears in the foreground to assist the user only under certain specified conditions. Accordingly, browsing agent client 24 displays a configuration interface that allows the user to configure the agent. For example, and in one embodiment, the browsing agent includes the ability to automatically operate on page-based interfaces (see above) and the ability to perform searches of the Internet based on the user's activity on browser 22 (discussed more fully below). According to this embodiment, the configuration interface allows the user to turn-off one or both command options.

After browsing agent client 24 has been configured, it drops into the background and subsequently monitors the user's activity (click stream) on browser 22. (See FIG. 3, step 204.) As with the first preferred embodiment, such monitoring may comprise sending the URL and the content of the currently viewed page to browsing agent server 42 and receiving control data, if profile database 46 indicates that a form exists on that page. In the second preferred embodiment, however, browsing agent client 24 monitors other aspects of the user's activity and transmits other click stream data to server 42.

For example, the second embodiment of the present invention has application to the on-line music store paradigm, discussed above. As is conventional, the user navigates through the on-line music store and selects various compact discs and audio tapes he wishes to purchase. As discussed above, as the user navigates among the various web pages provided by the on-line music store web server, browsing agent client 24 transmits corresponding addresses to browsing agent server 42, which looks for matches in profile database 46. When the user indicates that he is ready to purchase his selections, the on-line music store presents a web page having an interface including certain data fields. These data fields may include the user's name, address, telephone number, credit card number and expiration date. According to the invention, the address corresponding to this web page is communicated to browsing agent server 42 which finds a corresponding entry in profile database 46. Browsing agent server 42 then accesses master user database 48 and formats the data corresponding to the user's account as discussed above in the description of the first preferred embodiment. In addition, browsing agent client 24 also scans the currently viewed page for the fields describing the compact discs or other products the user intends to purchase. It then transmits this product information (click stream data) to browsing agent server 42. In preferred form, browsing agent transmits the Uniform Product Code (“UPC”) number corresponding to each product to browsing agent server 42.

With this click stream data, browsing agent server 42 accesses search engine server 44 (See FIG. 1A.) Using the UPC number, product name or any other relevant information, search engine server 44 searches other web sites connected to the Internet 60 that may contain information about the product(s) the user intends to purchase. In one preferred embodiment, for example, browsing agent client 24 allows the user to configure the agent to help the user to engage in comparison shopping or to obtain information related to the product, such as consumer report or manufacture's information. If search engine server 44 finds information that is consistent with the agent configuration, it transmits it to browsing agent client 24. Otherwise, browsing agent client 24 monitors subsequent user activity. (See FIG. 3, steps 204 and 206.)

If related information is received from browsing agent server 42, the command option to display such information is offered to the user. (See FIG. 3, step 208.) If the user selects the command option, the results of the search are displayed. As discussed above, browsing agent client 24 appears in the foreground and displays, for example, a list of other web sites and the offering price for the searched product. In addition, browsing agent client 24 may offer consumer report information, if such information is available and found. As one skilled in the art can imagine, search engine server 44 can perform such searches in a variety of ways. For purposes of the present invention and the scope of the claims submitted herewith, neither the configuration of the search engine server nor the manner in which it operates is critical to the present invention. As above, browsing agent resumes its monitoring of the click stream after the user selects the command option.

In addition, as FIG. 3 illustrates, the browsing agent of the second preferred embodiment transmits the agent configuration along with click stream data. (See FIG. 3, step 204.) According to this embodiment, browsing agent server 42 only transmits back control data or information that is consistent with the particular agent configuration. For example, if, during agent configuration, the user disables automatic page-based interface operation and enables a comparison shopping mode, browsing agent nevertheless transmits the URL of the currently viewed page. However, browsing agent server 42, having received the agent configuration, does not transmit an interface profile or other control data related to page-based interfaces.

FIG. 4, on the other hand, illustrates a third preferred method of the invention. In step 304 of the third preferred method of the present invention, browsing agent client 24 transmits click stream data to browsing agent server 42 and receives control data in return (e.g. interface profiles or related information searching). However, unlike the third preferred embodiment, browsing agent client 24 does not transmit the agent configuration. Rather, if control data is received (step 306), browsing agent evaluates whether the control data is consistent with the agent configuration (step 308). If the user has disabled the command option corresponding to such control data, browsing agent will not appear in the foreground to offer the user the command option. However, in a fourth preferred embodiment, the user can separately invoke browsing agent client 24 (step 314). If browsing agent client 24 is invoked, it similarly offers all available command options to the user.

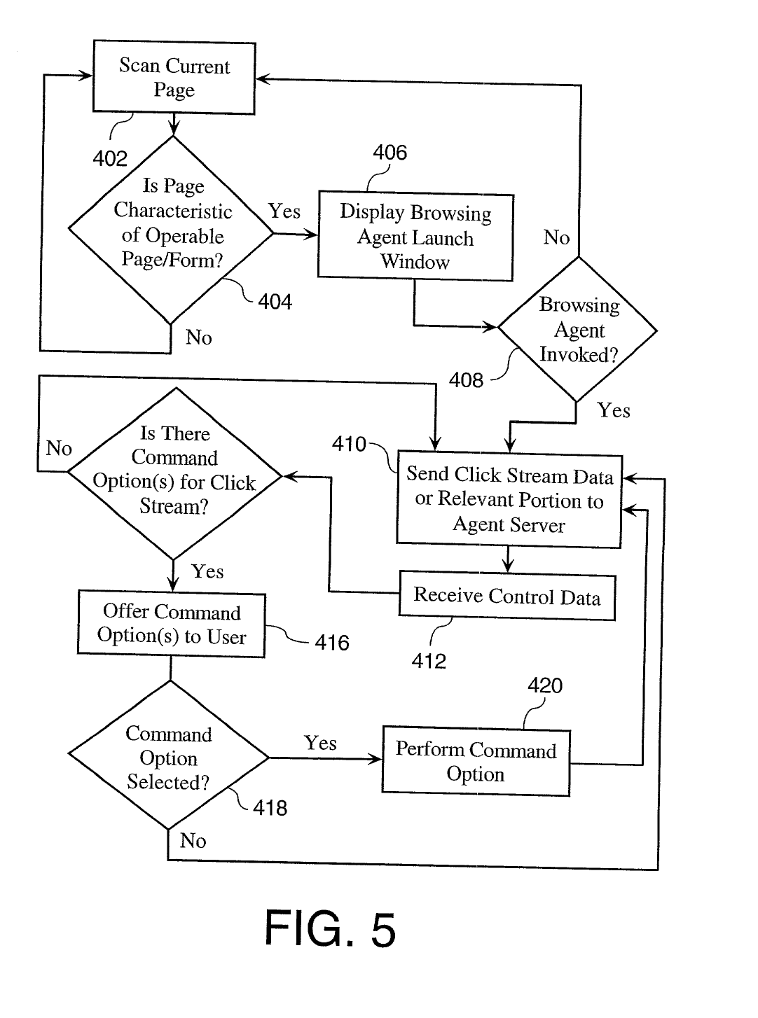

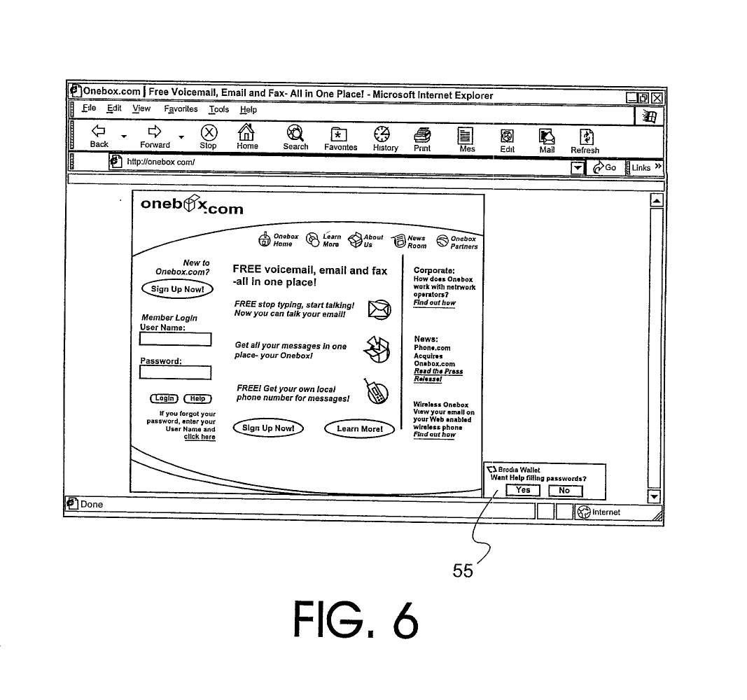

FIG. 5 illustrates another embodiment of the present invention, wherein browsing agent client 24 is configured to operate in a limited, less obtrusive mode and display a browsing agent launch window (FIG. 6, Ref. No. 55) allowing the user to launch the full functionality of the agent. In one embodiment, browsing agent client 24 is configured to scan the contents of the currently viewed page or file displayed by browser 22 for characteristics indicative of a form or page upon which browsing agent client 24 can operate. In one embodiment, if the form or page includes such characteristics, browsing agent client 24 displays browsing agent launch window 55 allowing the user to launch the full functionality of browsing agent client 24 such that it transmits clickstream data to browsing agent server 42 and receives control data in return. Accordingly and in one embodiment, clickstream data is transmitted to agent server 42 and the full functionality of browsing agent client 24 is employed, only if the user specifically invokes browsing agent client 24. In one embodiment, this configuration eliminates the delays often associated with transmitting clickstream data over computer network 40 and receiving control data in return, until it is likely that the agent can operate on the currently viewed page and the user elects to launch browsing agent client 24.

FIG. 6 illustrates a method according to one embodiment consistent with the principles described above. In one embodiment, browsing agent client 24, operating in a limited mode, scans the page currently displayed by browser 22 (FIG. 5, step 402). In one form, browsing agent client 24, in its limited mode, is executed by an application native to the operating system of client computer 20 and is configured using the APIs presented by browser 22 to monitor the user's session to scan the currently viewed page or form. For example, browsing agent client 24 can be configured to use Microsoft's IWebBrowser2 interface to scan pages, when a user uses Microsoft's Internet Explorer browser product. Similarly, browsing agent client 24 can be configured using the Netscape Navigator DDE interface to scan pages displayed by Netscape's Navigator browser. Of course, the specific interfaces or techniques employed depend on the functionality of the particular browsing software used on client computer 22. As it scans the page or form, browsing agent client 24 compares the elements of the page or form to characteristics indicative of a page or form upon which browsing agent, in its fully launched mode, can operate (FIG. 5, step 404). For example and in one embodiment, browsing agent client 24 scans a page for at least one characteristic or a combination of characteristics indicative of a “log-in” form or a “check out” form. For example, browsing agent client 24 scans each page or form for a password field, which indicates that the page is a log-in form. In other embodiments, other rules can be applied; for example, another characteristic indicative of a “log-in” form is that there are no text boxes or other input fields after the password field. In another embodiment, browsing agent client 24 also monitors pages or forms which include elements characteristic of a “check out” form, which a user typically fills out to complete an electronic commerce transaction. According to one example, browsing agent client 24 scans the form or page for one or a combination of fields, such as “name,” “billing address,” “shipping address,” “credit card number,” and any other fields characteristic of a “check out” form. Of course, other types of forms or pages including other characteristic elements may be incorporated into embodiments of the present invention. In another embodiment, browsing agent client 24 transmits clickstream data to agent server 42 and receives control data in return. According to this embodiment, browsing agent client 24 displays browsing agent launch window 55, allowing the user to launch the browsing agent, if browsing agent client 24 can operate on the current form or page.

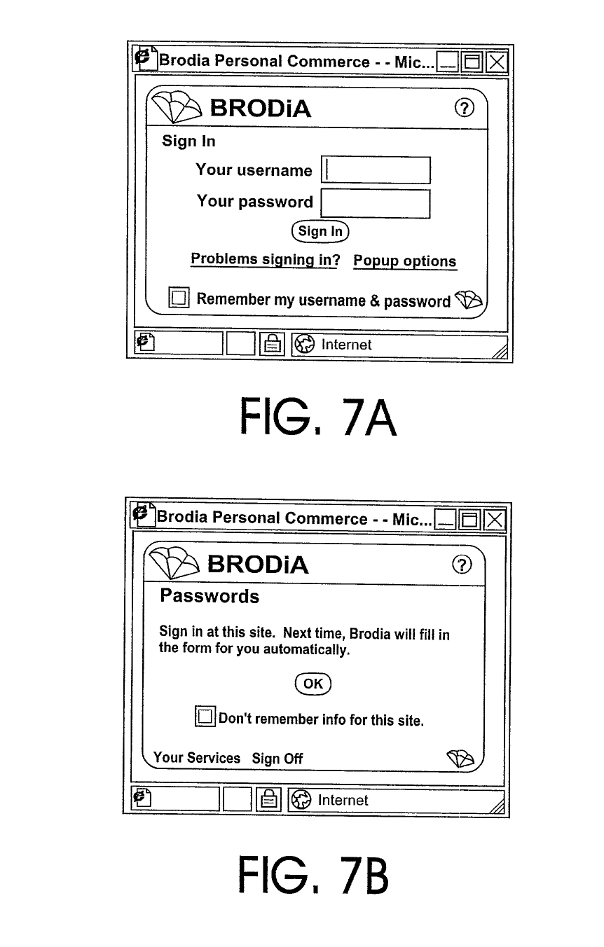

According to one embodiment, if the page or form includes elements characteristic of a form or page upon which browsing agent client 24 can operate (FIG. 5, step 404), browsing agent client 24 displays browsing agent launch window 55 (FIG. 5, step 406). (See also FIG. 6). In one form, browsing agent launch window 55 disappears, if the user does not activate it within a predetermined amount of time. In one embodiment, launch window 55 also disappears when the user has navigated to a page that does not include elements characteristic of a page upon which browsing agent client 24 can operate. In one embodiment, if the user invokes browsing agent client 24 via browsing agent launch window 55 (FIG. 5, step 408), the remaining functionality of browsing agent client 24 is launched. In one embodiment, the remaining functionality of browsing agent client 24 is launched in a new browser window. Of course, in other embodiments, the full functionality of browsing agent client 24 can operate as an application separate from browser 22. In one embodiment, as described above, browsing agent client 24 transmits clickstream data to browsing agent server 42 (step 410) and receives control data in return (step 412). In one embodiment, if the user has not logged in with browsing agent server 42, the user is prompted to provide a user name and password (see FIG. 7A). If a command option exists corresponding to the clickstream data (step 414), browsing agent client 24 displays it to the user (step 416). For example and in one embodiment, browsing agent client 24 displays an interface allowing the user to have the log-in form of FIG. 6 automatically filled out (see FIG. 7B). In one embodiment, the interface appears as a separate browser window. In another embodiment, the interface appears as a separate application window. Lastly, as described above, if the user elects to have browsing agent client 24 perform the command option (FIG. 5, step 41 8), browsing agent client 24 operates on the form according to control data transmitted by browsing agent server 42 (step 420). In one embodiment, browsing agent client 24 operates in its full mode until the user terminates it.

Browsing agent launch window 55 can take many forms. In one embodiment, the browsing agent launch window allows the user the option to terminate operation of even the limited mode of browsing agent client 24. In one embodiment, the browsing agent launch window appears as a tool bar in the browser application window itself. For example, such a tool bar can be created using interfaces presented by the particular browser 22 on client computer 20. Examples of such interfaces include Microsoft's Browser Helper and Band Objects APIs for Internet Explorer® browsers. In another embodiment, browsing agent launch window 55 appears as a separate application window. In one preferred embodiment, browsing agent launch window 55 comprises between 1 and 10 percent of the total viewing area of the display. In another embodiment, browsing agent launch window 55 comprises between 1 and 10 percent of the browser application window. As shown in FIG. 6, in one preferred embodiment, browsing agent launch window 55 lies along an edge of the browser application window. In another embodiment, browsing agent launch window 55 lies along an edge of the browser application window (see FIG. 6). In another embodiment, browsing agent launch window 55 lies along an edge of the display. As FIG. 6 shows, in one embodiment, browsing agent launch window 55 extends from the lower horizontal edge of the browser application window or display. In one embodiment, the vertical dimension of the browsing agent launch window spans between 5 and 10 percent of the application window or display. Of course, browsing agent launch window 55 can be configure to extend from the upper or a lateral edge of the application window or display.

With respect to the above-provided description, one skilled in the art will readily recognize that the present invention has application in a variety of contexts. The foregoing description illustrates the principles of the present invention and provides examples of its implementation. For example, although a preferred embodiment is described as working in conjunction with an Internet browser, the present invention may be used in connection with any suitable software application for accessing files throughout a computer network. Accordingly, the description is not intended to limit the scope of the claims to the exact embodiments shown and described.

What is claimed is:

1. A method for enhancing access to information on a computer network, said computer network carrying and routing data between computers connected thereto, said computers including at least one client computer associated with one or more users, at least one server associated with a provider of goods, services or information, and at least one browsing agent server associated with an autonomous browsing agent, said method comprising the steps of
(a) monitoring clickstream data for elements characteristic of data upon which said browsing agent can operate;
(b) displaying a browsing agent launch window on a display, said browsing agent window allowing said user to launch said browsing agent.

2. The method of claim 1 further comprising the steps of
(c) if said user launches said browsing agent, transmitting click stream data to said browsing agent server;
(d) receiving control data corresponding to said click stream data; and
(e) displaying a command option to said user, if one exists.

3. The method of claim 1 further comprising the step of
(f) repeating steps (a)-(e) a desired number of times.

4. The method of claim 1, 2 or 3 wherein said browsing agent window comprises between 1 and 10 percent of the total viewing area of said display.

5. The method of claim 1, 2 or 3 wherein said browsing agent window comprises between 1 and 10 percent of the total window displaying the user's browsing session.

6. The method of claims 1, 2, 3, 4 or 5 wherein said browsing agent window is displayed for a predetermined amount of time.

7. The method of claim 6 wherein said browsing agent window vanishes, if said user does not elect to launch said browsing agent within said predetermined amount of time.

8. The method of claim 1 wherein said browsing agent window lies along an edge of the display.

9. The method of claim 1 wherein said browsing agent window lies along an edge of the window displaying the user's browsing session.

10. The method of claim 8 or 9 wherein said edge is the lower horizontal edge.

11. The method of claim 8 wherein said browsing agent window extends upwardly from said lower horizontal edge of said display.

12. The method of claim 11 wherein the vertical dimension of said browsing agent window spans between 5 and 10 percent of said display.

13. The method of claim 8 wherein said browsing agent window extends upwardly from said lower horizontal edge of said window.

14. The method of claim 11 wherein the vertical dimension of said browsing agent window spans between 5 and 10 percent of said window.

15. The method of claim 1 wherein said scanning step (a) occurs at said client computer.

16. An apparatus operably connected to a computer network, the computer network carrying and routing data between computers connected thereto, the computers including a browsing agent server configured to facilitate operation of network access devices, comprising
a display device,
a network access module, the network access module facilitating access to and display of data transmitted over the computer network; and
a browsing agent client, the browsing agent client, in a limited mode, monitoring the clickstream associated with the network access module for indications that the browsing agent client may be operable; wherein the browsing agent client presents a browsing agent launch control on the display device when the browsing agent client may be operable, the browsing agent launch control facilitating launch of additional functionality of the browsing agent client.

17. The apparatus of claim 16 wherein the network access module is a browser.

18. The apparatus of claim 16 wherein, if the browsing agent launch control is activated, the browsing agent client operates in an on-line mode to transmit clickstream data to the browsing agent server and receive control data corresponding to the clickstream data.

19. The apparatus of claim 18 wherein the browsing agent client presents a command option, if one exists, associated with the control data.

20. The apparatus of claim 16 wherein the browsing agent launch control comprises a window spanning between 1 and 10 percent of the total viewing area of the display device.

21. The apparatus of claim 16 wherein the browsing agent launch control comprises a window spanning between 1 and 10 percent of the total window displaying the user's browsing session.

22. The apparatus of claim 16 wherein the browsing agent launch control is displayed for a predetermined amount of time.

23. The apparatus of claim 22 wherein the browsing agent launch control vanishes, if the user does not elect to launch the browsing agent within the predetermined amount of time.

24. The apparatus of claim 16 wherein the browsing agent launch control lies along an edge of the display.

25. The apparatus of claim 16 wherein the browsing agent launch control lies along an edge of the window displaying the user's browsing session.

26. A system allowing for enhanced access to information and services over a computer network, the computer network carrying and routing data between computers connected thereto, comprising
at least one network access device operably connected to the computer network; and
a browsing agent server operably connected to the computer network;
the browsing agent server configured to facilitate operation of network access devices in conjunction with a browsing agent client,
the network access device comprising a display device and a network access module, the network access module facilitating access to and display of data transmitted over the computer network; and, a browsing agent client, the browsing agent client monitoring, in a limited mode, the clickstream associated with the network access module for indications that the browsing agent client may be operable; wherein the browsing agent client presents a browsing agent launch control on the display device when the browsing agent client may be operable, the browsing agent launch control facilitating launch of additional functionality of the browsing agent client;
the browsing agent client, when launched, transmitting clickstream data to the browsing agent server and receiving control data in return.

27. The system of claim 26 wherein the network access module is a browser.

28. The system of claim 26 wherein the browsing agent client presents a command option, if one exists, associated with the control data.

29. A system allowing for enhanced access to information and services over a computer network, the computer network carrying and routing data between computers connected thereto, comprising
at least one network access device operably connected to the computer network; and
a browsing agent server operably connected to the computer network;
the browsing agent server configured to facilitate operation of network access devices in conjunction with a browsing agent client,
the network access device comprising a network access module, the network access module facilitating access to and display of data transmitted over the computer network; and, a browsing agent client, the browsing agent client monitoring the clickstream associated with the network access module, the browsing agent client further transmitting clickstream data to the browsing agent server and receiving control data in return.

30. The system of 29 wherein the browsing agent client is operable to perform operations associated with the control data.

31. The system of claim 30 wherein the browsing agent client automates operation of page-based interfaces displayed by the network access module.

32. The system of claim 29 or 30 wherein the browsing agent client includes a user account database storing user data.

33. The system of claim 32 wherein the user data is stored in encrypted form.

34. The system of claim 33 wherein the browsing agent server is operable to authenticate users at the network access device; wherein the browsing agent server, after authentication of a user at the network access device, transmits a cryptographic key to the browsing agent client; the cryptographic key being operable to facilitate access to the encrypted user data stored in the user account database.

35. The system of claim 34 wherein the browsing agent client decrypts the encrypted user data with the cryptographic key and inserts the decrypted user data into the data fields of a form downloaded by the network access module according to the control data transmitted by the browsing agent server.

36. An apparatus allowing for enhanced access to information and services over a computer network, the computer network carrying and routing data between computers connected thereto, the computers including a browsing agent server, comprising
a network access module facilitating access to and display of data transmitted over the computer network; and
a browsing agent client, the browsing agent client monitoring the clickstream associated with the network access module, the browsing agent client further transmitting clickstream data to a browsing agent server and receiving control data in return.

37. The apparatus of claim 36 wherein the network access module is a browser.

38. The apparatus of claim 36 wherein the browsing agent client presents a command option, if one exists, associated with the control data.
